(19) United States
(12) Patent Application Publication
(10) Pub. No.: US 2016/0083226 A1
(43) Pub. Date: Mar. 24, 2016

(54) LINEAR MOTOR STATOR CORE FOR SELF-PROPELLED ELEVATOR

(71) Applicant: OTIS ELEVATOR COMPANY, Farmington, CT (US)

(72) Inventors: Zbigniew Piech, Cheshire, CT (US); Cezary Jedryczka, Lniano (PL); Rafal Wojciechowski, Srem (PL); Jacek Mikolajewicz, Szwecja (PL); Piotr Sujka, Gniezno (PL); Wojciech Szelag, Poznan (PL); Piotr Lukaszewicz, Poznan (PL)

(21) Appl. No.: 14/889,235

(22) PCT Filed: May 6, 2013
(86) PCT No.: PCT/US2013/039615

§ 371 Date: Nov. 5, 2015

(51) Int. Cl. B66B 11/04

(52) U.S. Cl. CPC B66B 11/0407

(57) ABSTRACT

An elevator system includes a hoistway; an elevator car to travel in the hoistway; permanent magnets mounted to one of the elevator car and the hoistway; and a stator mounted to the other of the elevator car and the hoist way, the stator including windings coacting with the permanent magnets to control motion of the elevator car in the hoistway, the stator having a stator core supporting the windings, the stator core being electrically non-conductive.

### FIELD OF INVENTION

The subject matter disclosed herein relates generally to the field of elevators, and more particularly, to a linear motor stator core for a self-propelled elevator.

### BACKGROUND

Self-propelled elevator systems, also referred to as ropeless elevator systems, are useful in certain applications (e.g., high rise buildings) where the mass of the ropes for a roped system is prohibitive and/or there is a need for multiple elevator cars in a single hoistway.

### SUMMARY

According to an exemplary embodiment, an elevator system includes a hoistway; an elevator car to travel in the hoistway; permanent magnets mounted to one of the elevator car and the hoistway; and a stator mounted to the other of the elevator car and the hoistway, the stator including windings coacting with the permanent magnets to control motion of the elevator car in the hoistway, the stator having a stator core supporting the windings, the stator core being electrically non-conductive.

According to another exemplary embodiment, a propulsion system for an elevator system includes a stationary portion configured to be fixed a hoistway wall; and a moving portion configured to be fixed to an elevator cab; wherein one of the stationary portion and the moving portion comprises permanent magnets and the other of the stationary portion and the moving portion comprises windings; and wherein the permanent magnets and the windings are configured to coact to control the movement of the moving portion relative to the stationary portion.

Other aspects, features, and techniques of embodiments of the invention will become more apparent from the following description taken in conjunction with the drawings.

### BRIEF DESCRIPTION OF THE DRAWINGS

Referring now to the drawings wherein like elements are numbered alike in the FIGURES:

FIG. 1 depicts a self-propelled elevator system in an exemplary embodiment;

FIG. 2 depicts permanent magnets in an exemplary embodiment;

FIGS. 3 and 4 depict a stator and permanent magnets in an exemplary embodiment;

FIGS. 5 and 6 depict a stator and permanent magnets in another exemplary embodiment; and

FIGS. 7 and 8 depict a stator and permanent magnets in yet another exemplary embodiment.

### DETAILED DESCRIPTION

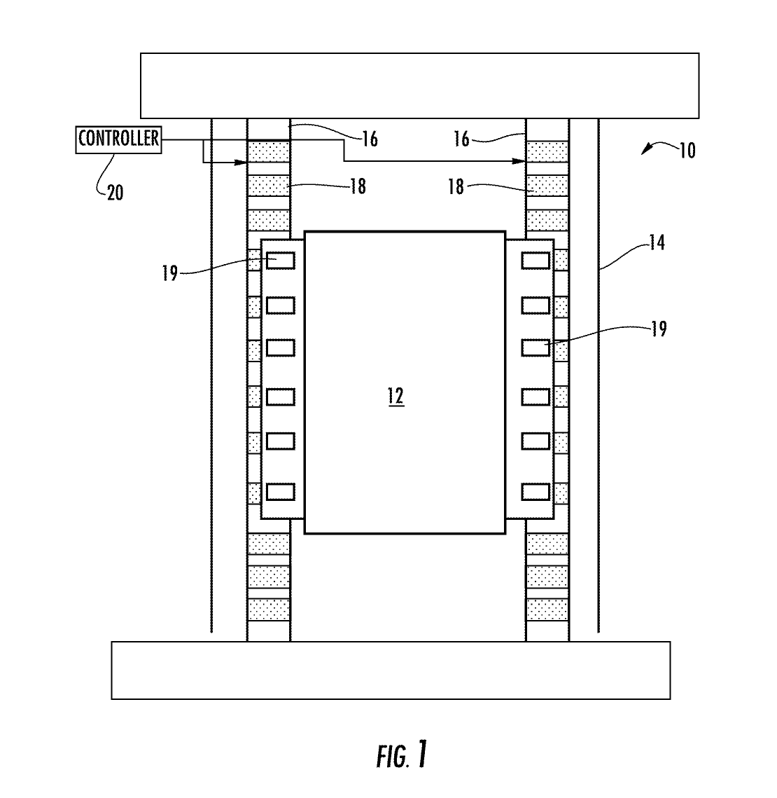

FIG. 1 depicts an elevator system 10 having a self-propelled elevator car 12 in an exemplary embodiment. Elevator system 10 includes an elevator car 12 that travels in a hoistway 14. Elevator car 12 is guided by one or more guide rails 16 extending along the length of hoistway 14. Elevator system 10 employs a linear motor having a stator 18 including a plurality of phase windings. Stator 18 may be mounted to guide rail 16, incorporated into the guide rail 16, or may be located apart from guide rail 16. Stator 18 serves as one portion of a permanent magnet synchronous linear motor to impart motion to elevator car 12. Permanent magnets 19 are mounted to car 12 to provide a second portion of the permanent magnet synchronous linear motor. Windings of stator 18 may be arranged in three phases, as is known in the electric motor art. Two stators 18 may be positioned in the hoistway 14, to coact with permanent magnets 19 mounted to elevator car 12. The permanent magnets 19 may be positioned on two sides of elevator car 12, as shown in FIG. 1. Alternate embodiments may use a single stator 18—permanent magnet 19 configuration, or multiple stator 18—permanent magnet 19 configurations.

A controller 20 provides drive signals to the stator(s) 18 to control motion of the elevator car 12. Controller 20 may be implemented using a general-purpose microprocessor executing a computer program stored on a storage medium to perform the operations described herein. Alternatively, controller 20 may be implemented in hardware (e.g., ASIC, FPGA) or in a combination of hardware/software. Controller 20 may also be part of an elevator control system. Controller 20 may include power circuitry (e.g., an inverter or drive) to power the stator(s) 18.

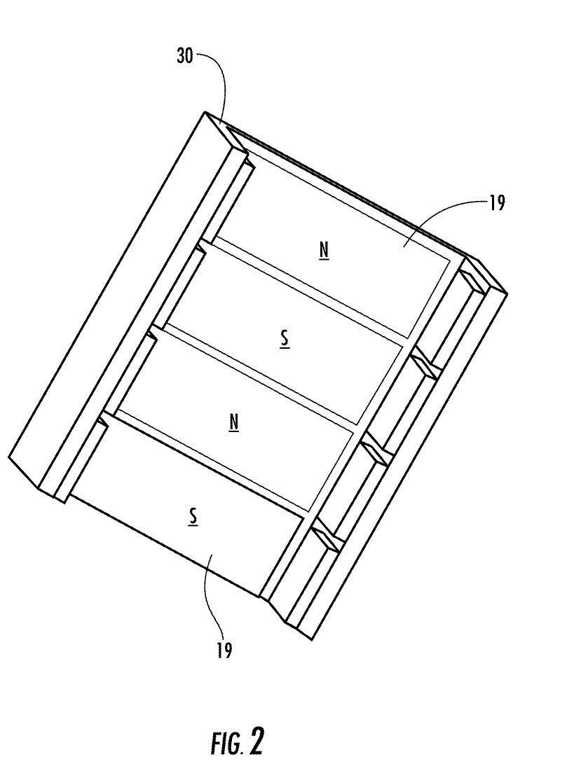

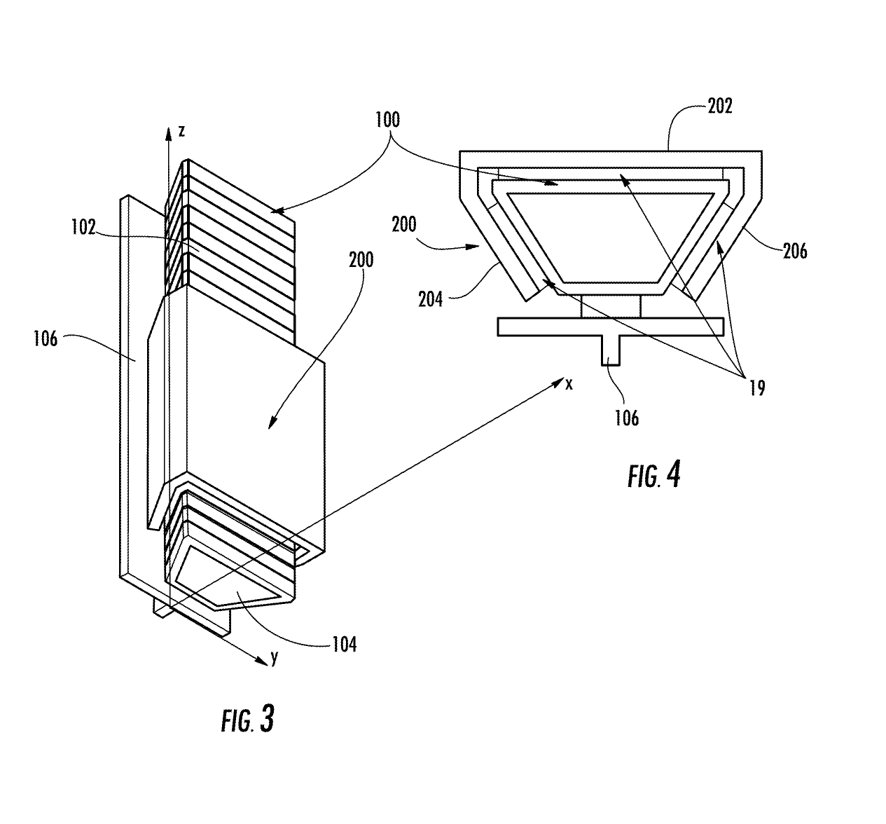

FIG. 2 depicts permanent magnets 19 in an exemplary embodiment. Permanent magnets 19 are mounted to a permanent magnet support 30. Various exemplary permanent magnets supports are described with reference to FIGS. 3-8 herein. FIG. 2 depicts the orientation of the magnetic poles of the permanent magnets 19. As shown in FIG. 2, the poles alternate North, South, North, South, etc. along the direction of travel of car 12.

FIG. 3 is a perspective view of a stator 100 and permanent magnet support 200 in an exemplary embodiment. Stator 100 includes a plurality of windings 102 formed about a stator core 104. Windings 102 may be arranged in a plurality of phases (e.g., three phases as shown, six phases, nine phases, two phases, etc.). Windings 102 may be formed using electrical conductors (e.g., wires, tape) such as copper or aluminium. Using aluminium (e.g., wires or tape) for windings 102 reduces the mass of the stator 102 and reduces the cost of installation. Stator 100 is mounted to a stator support 106, which may be a metal member secured to an inner wall of hoistway 14. Stator support 106 may also serve as a guide rail 16.

Stator core 104 is electrically non-conductive. In exemplary embodiments, stator core 104 may be constructed from an electrically non-conductive member having a desired shape. For example, a plastic, hollow member may be used for stator core 104. A hollow, at least partially, stator core 104 may be used to route wires, cables, etc., through hoistway 14. The plastic member may be filled with a curable material (e.g., concrete) to improve its strength. Other embodiments, described herein, include an electrically non-conductive, ferromagnetic stator core.

FIG. 4 depicts a permanent magnet support 200 having permanent magnets 19 positioned about stator 100. One or more permanent magnet supports 200 may be mounted to elevator car 12. Permanent magnet support 200 may be made from a ferromagnetic material (e.g., steel). To reduce the weight, permanent magnet support 200 may be made of aluminum (or a different light material). In such embodiments, the permanent magnets 19 may be arranged in a configuration other than that shown in FIG. 2 (e.g., in a Halbach array pattern).

Permanent magnet support 200 is arranged in a delta shape, having a first wall 202, second wall 204 and third wall 206. Permanent magnets 19 are mounted on the interior surfaces of first wall 202, second wall 204 and third wall 206. In alternate embodiments, permanent magnets 19 are embedded in the permanent magnet support 200. Permanent magnets 19 are positioned to be adjacent to and parallel with faces of stator 100. Second wall 204 and third wall 206 each have a first end joining first wall 202. Second wall 204 and third wall 206 taper towards each other with distance from first wall 202. Second wall 204 and third wall 206 each have a distal, second end, such that the distance between the second ends of the second wall 204 and third wall 206 is less than the distance between the first ends of the second wall 204 and third wall 206. Second wall 204 and third wall 206 may be planer or non-planer (e.g. having a bend, as shown in FIG. 4).

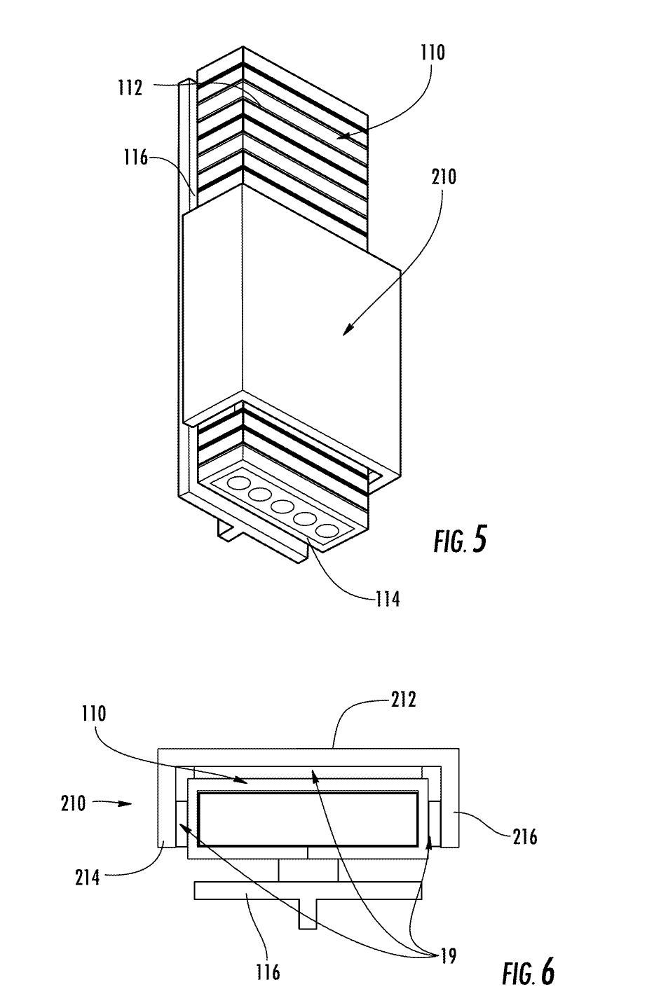

FIG. 5 is a perspective view of a stator 110 and permanent magnet support 210 in an exemplary embodiment. Stator 110 includes a plurality of windings 112 formed about a stator core 114. Windings 112 may be arranged in a plurality of phases (e.g., three phases). Windings 112 may be formed using electrical conductors (e.g., wires, tape) such as copper or aluminium. Using aluminium (e.g., wires or tape) for windings 112 reduces the mass of the stator 112 and reduces the cost of installation. Stator 110 is mounted to a stator support 116, which may be a metal member secured to an inner wall of hoistway 14. Stator support 116 may also serve as a guide rail 16.

Stator core 114 is electrically non-conductive. In exemplary embodiments, stator core 114 may be constructed from an electrically non-conductive member having a desired shape. For example, a plastic, hollow member may be used for stator core 114. A hollow, at least partially, stator core 114 may be used to route wires, cables, etc., through hoistway 14. The plastic member may be filled with a curable material (e.g., concrete) to improve its strength. Other embodiments, described herein, include an electrically non-conductive, ferromagnetic stator core.

FIG. 6 depicts a permanent magnet support 210 having permanent magnets 19 positioned about stator 110. One or more permanent magnet supports 210 may be mounted to elevator car 12. Permanent magnet support 210 may be made from a ferromagnetic material (e.g., steel). To reduce the weight, permanent magnet support 210 may be made of aluminum (or a different light material). In such embodiments, the permanent magnets 19 may be arranged in a configuration other than that shown in FIG. 2 (e.g., in a Halbach array pattern).

Permanent magnet support 210 is arranged in a U shape, having a first wall 212, second wall 214 and third wall 216. Permanent magnets 19 are mounted on the interior surfaces of first wall 212, second wall 214 and third wall 216. In alternate embodiments, permanent magnets 19 are embedded in the permanent magnet support 210. Permanent magnets 19 are positioned to be adjacent to and parallel with faces of stator 110. Second wall 214 and third wall 216 each have a first end joining first wall 212. Second wall 214 and third wall 216 are perpendicular to first wall 212. First wall 212 is longer than both second wall 214 and third wall 216.

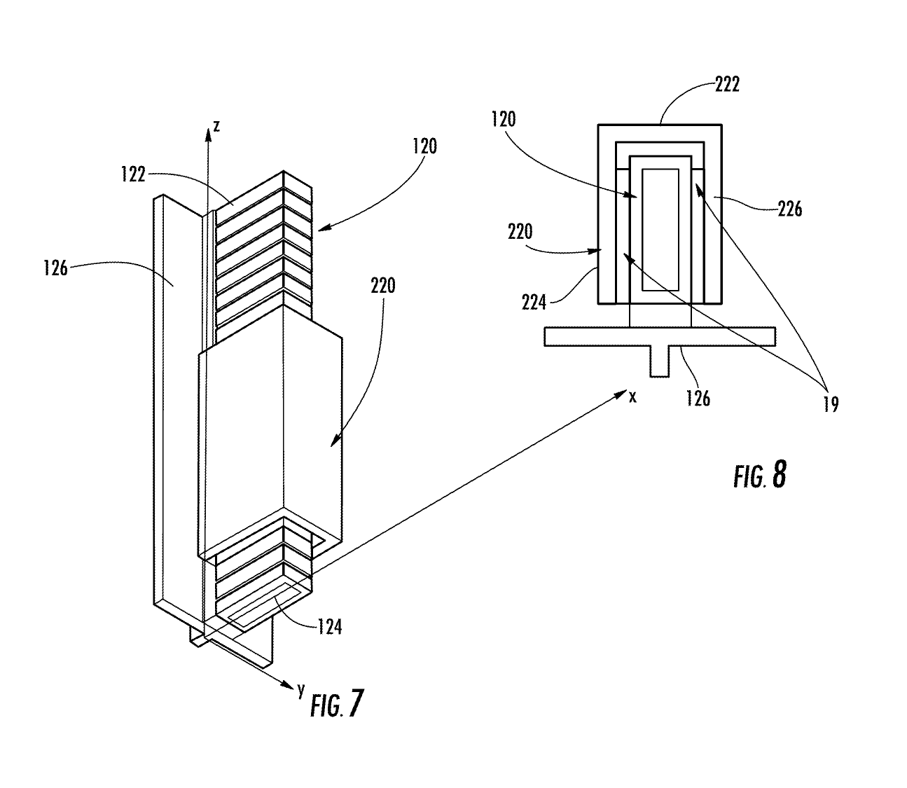

FIG. 7 is a perspective view of a stator 120 and permanent magnet support 220 in an exemplary embodiment. Stator 120 includes a plurality of windings 122 formed about a stator core 124. Windings 122 may be arranged in a plurality of phases (e.g., three phases). Windings 122 may be formed using electrical conductors (e.g., wires, tape) such as copper or aluminium. Using aluminium (e.g., wires or tape) for windings 122 reduces the mass of the stator 122 and reduces the cost of installation. Stator 120 is mounted to a stator support 126, which may be a metal member secured to an inner wall of hoistway 14. Stator support 126 may also serve as a guide rail 16.

Stator core 124 is electrically non-conductive. In exemplary embodiments, stator core 124 may be constructed from an electrically non-conductive member having a desired shape. For example, a plastic, hollow member may be used for stator core 124. A hollow, at least partially, stator core 124 may be used to route wires, cables, etc., through hoistway 14. The plastic member may be filled with a curable material (e.g., concrete) to improve its strength. Other embodiments, described herein, include an electrically non-conductive, ferromagnetic stator core.

FIG. 8 depicts a permanent magnet support 220 having permanent magnets 19 positioned about stator 120. One or more permanent magnet supports 220 may be mounted to elevator car 12. Permanent magnet support 220 may be made from a ferromagnetic material (e.g., steel). To reduce the weight, permanent magnet support 220 may be made of aluminum (or a different light material). In such embodiments, the permanent magnets 19 may be arranged in a configuration other than that shown in FIG. 2 (e.g., in a Halbach array pattern).

Permanent magnet support 220 is arranged in a double I shape, having a first wall 222, second wall 224 and third wall 226. Permanent magnets 19 are mounted on the interior surfaces of second wall 224 and third wall 226. In alternate embodiments, permanent magnets 19 are embedded in the permanent magnet support 220. Permanent magnets 19 are positioned to be adjacent to and parallel with faces of stator 120. Second wall 224 and third wall 226 each have a first end joining first wall 222. Second wall 224 and third wall 226 are perpendicular to first wall 222. First wall 22 is shorter than both second wall 224 and third wall 226.

In the above described embodiments, the stator is stationary and mounted in the hoistway 14 while the permanent magnets are mounted to elevator car 12. The linear motor can be also designed with the stator mounted to the elevator car 12 and the permanent magnets mounted along the hoistway 14.

FIG. 1 depicts a stator 18 and permanent magnets 19 on two sides of the car 12. In an exemplary embodiment, the permanent magnets 19 are located on the sides of car 12 along an axis projected through the center of gravity of the car 12. Positioning the permanent magnets 19 in this way reduces lateral forces acting on the car 12 that could cause excessive vibrations and mechanical instability. In other embodiments, permanent magnets 19 are mounted to a single side or corner of car 12. In such embodiments, an actively controlled guiding system may be used to compensate for torsional forces on car 12.

It is noted that the stator cores 104, 114 and 124 are toothless, meaning the stator does not rely on poles or other extensions with windings formed thereon. Rather, stator cores 104, 114 and 124 have continuous, planar surfaces. The toothless structure provides a low dependency of motor performance on size of the non-magnetic gap (i.e., the mechanical clearance between stationary stator and moving permanent magnets mounted on the elevator cars). This allows the linear motor to be designed with comfortable clearances between long stationary stators and permanent magnets mounted to moving cars. In addition, the toothless structure of the stator eliminates any cogging forces present in typical linear motor structures. Cogging forces modulating the linear motor are a frequent source of vibration and noise in elevator systems.

Additional embodiments employ a stator core that is electrically non-conductive and is ferromagnetic. A stator core utilizing electrically non-conductive, ferromagnetic material offers a reduced size linear motor along the hoistway. In one embodiment, the stator core is made from a sintered soft magnetic composition of ferromagnetic powder (e.g., Somaloy™). In another embodiment, the stator core is made from a mixture of a curable material (e.g., resin) and soft ferromagnetic powder. In another embodiment, the stator core is made from a mixture of a curable material (e.g., polymers and/or concrete) with a ferromagnetic material (e.g., ferromagnetic powder and/or ferromagnetic metal). In another embodiment, the stator core is made from laminated steel sheets.

Embodiments of the invention provide numerous benefits. Embodiments described herein provide a linear motor having reduced dimensions when compared to possible other solutions. The smaller size offers lower mass of electromagnetically active materials, controlling the cost and space utilization in the hoistway. Manufacturing the stator core is simplified. Large elements of the stator core may be fabricated (1) with a sintering process (2) by injection molding of mixed ferromagnetic material with epoxy resins or (3) by partial encapsulation of the stator module with mixed plastic/concrete/ferromagnetic powder. Using an electrically non-conductive, ferromagnetic stator core increases the magnetic field in the motor air gap which leads to a decrease of excitation current and lower conductive losses. Moreover, the electrically non-conductive, ferromagnetic stator core eliminates eddy currents in the stator core which further reduces power losses and heat generated in the stator core when compared to a laminated steel core.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description, but is only limited by the scope of the appended claims.

1. An elevator system comprising:
a hoistway;
an elevator car to travel in the hoistway;
permanent magnets mounted to one of the elevator car and the hoistway; and
a stator mounted to the other of the elevator car and the hoistway, the stator including windings coacting with the permanent magnets to control motion of the elevator car in the hoistway, the stator having a stator core supporting the windings, the stator core being electrically non-conductive.

2. The elevator system of claim 1 wherein:
the permanent magnets are supported on a permanent magnet support.

3. The elevator system of claim 2 wherein:
the permanent magnets are mounted on an interior surface of the permanent magnet support.

4. The elevator system of claim 2 wherein:
the permanent magnets are embedded in the permanent magnet support.

5. The elevator system of claim 2 wherein:
the permanent magnet support has a first wall, second wall and third wall, the second wall and third wall joined to the first wall, the second wall and third wall tapering towards each other.

6. The elevator system of claim 2 wherein:
the permanent magnet support has a first wall, second wall and third wall, the second wall and third wall joined to the first wall, the second wall and third wall being perpendicular to the first wall.

7. The elevator system of claim 1 wherein:
the permanent magnets are positioned to be adjacent to and parallel with an external surface of the windings.

8. The elevator system of claim 1 wherein:
the stator core is at least partially hollow.

9. The elevator system of claim 1 wherein:
the stator core includes a cured material.

10. The elevator system of claim 9 wherein:
the cured material is concrete.

11. The elevator system of claim 1 further comprising:
a ferromagnetic material in the stator core.

12. The elevator system of claim 11 wherein:
the stator core is made from a sintered magnetic composition of ferromagnetic powder.

13. The elevator system of claim 11 wherein:
the stator core is made from a mixture of a curable material and ferromagnetic powder.

14. The elevator system of claim 11 wherein:
the stator core is made from a mixture of a curable material and a ferromagnetic metal.

15. The elevator system of claim 1 wherein:
the stator core is toothless.

16. A propulsion system for an elevator system, the propulsion system comprising:
a stationary portion configured to be fixed a hoistway wall; and
a moving portion configured to be fixed to an elevator cab;
wherein one of the stationary portion and the moving portion comprises permanent magnets and the other of the stationary portion and the moving portion comprises windings; and
wherein the permanent magnets and the windings are configured to coact to control the movement of the moving portion relative to the stationary portion.

17. The propulsion system of claim 16, wherein the windings of the one of the stationary portion and the moving portion comprising windings are formed around an electrically non-conductive inner core.

18. The propulsion system of claim 17, wherein the electrically non-conductive inner core has a trapezoidal cross section.

19. The propulsion system of claim 17, wherein the electrically non-conductive inner core comprises ferromagnetic materials.

20. The propulsion system of claim 17, wherein the electrically non-conductive inner core comprises a plurality of channels configured to accommodate cabling.
